(19) United States
(12) Patent Application Publication
(10) Pub. No.: US 2019/0018707 A1
(43) Pub. Date: Jan. 17, 2019

(54) PARALLEL PROCESSING CONTROL DEVICE AND COMPUTER SYSTEM

(71) Applicant: FUJITSU LIMITED, Kawasaki-shi (JP)

(72) Inventors: Tsutomu Ueno, Numazu (JP); Tsuyoshi HASHIMOTO, Kawasaki (JP)

(73) Assignee: FUJITSU LIMITED, Kawasaki-shi (JP)

(21) Appl. No.: 16/028,579

(22) Filed: Jul. 6, 2018

(30) Foreign Application Priority Data
Jul. 14, 2017 (JP) 2017-137720

(51) Int. Cl. G06F 9/50; H04L 29/08; G06F 9/52

(52) U.S. Cl. CPC G06F 9/5016; G06F 9/52; H04L 67/1008; H04L 67/101

(57) ABSTRACT

A parallel processing control device includes a processor that acquires path status information indicating a communication status of each path connecting between compute nodes. The processor acquires free memory information indicating a status of memory usage in each compute node. The processor determines, when a new job is input, a save target job from among jobs processed by at least a part of the compute nodes. The processor determines, by evaluating data transfer from the respective compute nodes to respective acceptable nodes based on the free memory information and the path status information, destination nodes and a size of data to be transferred between respective pairs of one source node and one destination node. The acceptable nodes are compute nodes having a free memory. The destination nodes are compute nodes to which a part of data of the save target job is to be transferred from the respective source nodes.

### CROSS-REFERENCE TO RELATED APPLICATION

This application is based upon and claims the benefit of priority of the prior Japanese Patent Application No. 2017-137720, filed on Jul. 14, 2017, the entire contents of which are incorporated herein by reference.

### FIELD

The embodiments discussed herein are related to a parallel processing control device and a computer system.

### BACKGROUND

A parallel computer system includes plural compute nodes connected to each other via a network and allocates jobs to the plural compute nodes that process the jobs in parallel. A compute node may be referred to as a computer resource.

The parallel computer system is also provided with a job management node that performs scheduling such as allocation of jobs to be processed to computer resources and management of job processing time in computer resources.

In the parallel computer system, when an emergency job that is urgently required to be processed is input, in a case where there is no space allocable for computer resources, this emergency job is unable to be processed.

In this way, a job unable to be processed due to absence of allocable free computer resources may be referred to as a job waiting for free computer resources.

In a conventional parallel computer system, when an emergency job waiting for a computer resource space occurs, a computer resource is allocated to this emergency job after other jobs currently being executed by other computer resources are stopped.

At this time, at a compute node of an allocation destination of this emergency job, there is a need to stop the job being executed and swap out the data of the memory (which may hereinafter be referred to as swap data) to, for example, a disk device (swap-out). The calculation result of the job processed at the compute node is stored in the memory. Therefore, transferring the memory data to another compute node may be equivalent to transferring a job.

Related techniques are disclosed in, for example, Japanese National Publication of International Patent Application No. 2016-519378, International Publication Pamphlet No. WO 2013/145512, and Japanese Laid-Open Patent Publication No. 2016-224832.

### SUMMARY

According to an aspect of the present invention, provided is a parallel processing control device including a memory and a processor coupled to the memory. The processor is configured to acquire path status information indicating a communication status of each path connecting between compute nodes. The processor is configured to acquire free memory information indicating a status of memory usage in each of the compute nodes. The processor is configured to determine, when a new job is input, a save target job from among jobs processed by at least a part of the compute nodes. The processor is configured to determine, by evaluating data transfer from the respective compute nodes to respective acceptable nodes based on the free memory information and the path status information, destination nodes and a size of data to be transferred between respective pairs of one of source nodes and one of the destination nodes. The acceptable nodes are compute nodes having a free memory. The destination nodes are compute nodes to which a part of data of the save target job is to be transferred from the respective source nodes. The source nodes are compute nodes processing the save target job.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration of a parallel computer system according to an embodiment;

FIG. 2 is a block diagram illustrating an example of a hardware configuration of a compute node of the parallel computer system according to the embodiment;

FIG. 3 is a block diagram illustrating an example of a functional configuration of the compute node in the parallel computer system according to the embodiment;

FIG. 4 is a block diagram illustrating an example of a hardware configuration of a job management node of the parallel computer system according to the embodiment;

FIG. 5 is a block diagram illustrating an example of a functional configuration of the job management node in the parallel computer system according to the embodiment;

FIG. 6 is a view for explaining a method of determining a job swap source and a job swap destination in the parallel computer system according to the embodiment;

FIG. 7 is a view for explaining a method of determining a job swap destination in the parallel computer system according to the embodiment;

FIG. 8 is a view for explaining a method of determining a job swap destination in the parallel computer system according to the embodiment;

FIG. 9 is a view for explaining a method of determining a job swap destination in the parallel computer system according to the embodiment; and

FIG. 10 is a flowchart for explaining a process of a job management node when an emergency job is input in the parallel computer system according to the embodiment.

### DESCRIPTION OF EMBODIMENTS

In a parallel computer system, in a compute node determined as an allocation destination of an emergency job, there may be a case where it is not possible to secure a free memory space required to execute an emergency job. In such a case, in a compute node of the allocation destination of the emergency job, a free area is secured in the memory when the swap data on the memory starts to be written into a disk device such as a HDD (Hard Disk Drive).

However, since the I/O (Input/Output) performance of a disk device is generally poor, the process of job swap accompanying the I/O to the disk device takes a time until an emergency job may be executed.

Therefore, instead of writing the swap data in the disk device, it is conceivable to use an unused area (free area) of the memory of another node provided on the parallel computer system as a cache for swap data.

By transferring the swap data on the memory of one compute node that was executing a job to the memory of another compute node, the job executed in the one compute node is transferred to the another compute node. Hereafter, transferring the swap data of one compute node to the memory of another compute node may be referred to as a job swap.

Hereinafter, a node provided on a parallel computer system and having a free area in its memory may be sometimes referred to as a free node. Further, a compute node on the side where swap data starts to be written may be sometimes referred to as a swap source node. Furthermore, a compute node having a memory used as a swap data cache and used as a swap destination may be sometimes referred to as a swap destination node.

When performing a job swap to use a free node memory as a swap destination, there is a large difference in the processing performance of the job swap depending on a combination of the swap source node and the swap destination node for the reasons described below.

That is, the communication bandwidth in the communication path from the swap source node to the swap destination node takes various values from time to time depending on the combination of the swap source node and the swap destination node. This is because this change in communication bandwidth affects the processing time of swap-out.

In addition, in the parallel computer system, it is thought that the degree of interference with communications caused by other jobs affects the change in communication bandwidth on a communication path between compute nodes and between a compute node and an I/O node. Here, the I/O node refers to a node used for communicating with an external device of the parallel computer system.

Therefore, in the conventional parallel computer system, there is a problem that it is difficult to determine an optimum swap destination node when performing a job swap between compute nodes in order to use a free node memory as a swap destination.

Embodiments related to a parallel processing control device and a job swap program will be described below with reference to the accompanying drawings. However, the following embodiments are merely examples but are not intended to exclude application of various modifications and techniques not explicitly described in the embodiments. That is, the embodiments may be implemented with various modifications without departing from the gist of the present disclosure. Further, each figure is not intended to include only constituent elements illustrated in the figure but may include, for example, other functions.

(1) Configuration

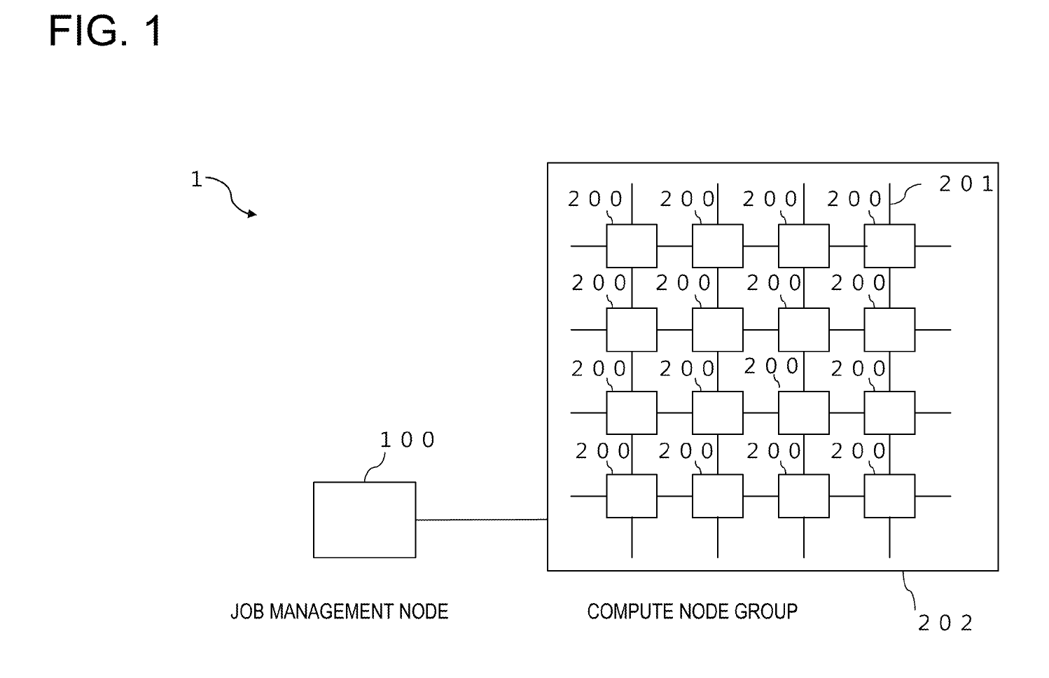

FIG. 1 is a view illustrating a configuration of a parallel computer system 1 according to an embodiment.

As illustrated in FIG. 1, the parallel computer system 1 includes a compute node group 202 and a job management node 100.

The compute node group 202 includes plural compute nodes 200 connected so as to communicate with each other via a network 201, thereby constituting an N-dimensional interconnection network (N is a natural number). The job management node 100 is connected to the network 201.

The network 201 is a communication line such as, for example, a LAN (Local Area Network) or an optical communication path.

(1-1) Compute Node 200

The plural compute nodes 200 included in the compute node group 202 are information processing apparatuses and have the same configuration.

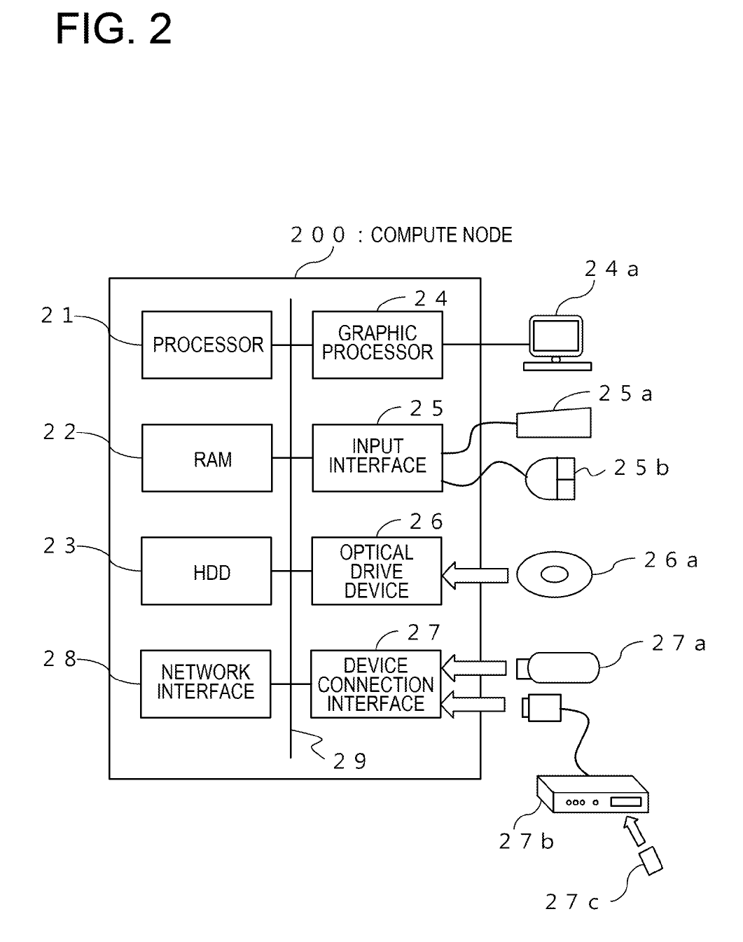

FIG. 2 is a block diagram illustrating an example of a hardware configuration of a compute node 200 of the parallel computer system 1 according to the embodiment.

The compute node 200 includes, for example, a processor 21, a RAM 22, an HDD 23, a graphic processor 24, an input interface 25, an optical drive device 26, a device connection interface 27, and a network interface 28. These components 21 to 28 are configured to communicate with each other via a bus 29.

The RAM 22 is used as a main memory device of the compute node 200. At least part of an OS program and an application program to be executed by the processor 21 is temporarily stored in the RAM 22. Various data required for processing by the processor 21 are stored in the RAM 22. The application program may include a compute node control program to be executed by the processor 21 to implement the job computation processing function and the compute node management function in the compute node 200.

In the parallel computer system 1, when the processor 21 executes a job, for example, the data generated when the job is executed are stored in the RAM 22. Then, the data in the RAM 22 are transmitted to the other compute nodes 200 (the swap destination compute nodes 200) as swap data.

Further, the swap data transmitted from the other compute node 200s (the swap source compute nodes 200) may be stored in a free area of the RAM 22.

The HDD 23 is used as an auxiliary memory device of the compute node 200. The HDD 23 stores the OS program, the application program, and the various data.

A monitor 24a is connected to the graphic processor 24. The graphic processor 24 displays an image on the screen of the monitor 24a in accordance with an instruction from the processor 21. Examples of the monitor 24a may include, for example, a display device using a CRT (Cathode Ray Tube) or a liquid crystal display device.

A keyboard 25a and a mouse 25b are connected to the input interface 25. The input interface 25 transmits a signal sent from the keyboard 25a and the mouse 25b to the processor 21. The mouse 25b is an example of a pointing device, but other pointing devices may also be used. Examples of other pointing devices may include, for example, a touch panel, a tablet, a touch pad, and a track ball.

The optical drive device 26 uses, for example, laser light to read data recorded on an optical disk 26a. The optical disk 26a is a portable non-transitory recording medium in which data is recorded so as to be readable by reflection of light. Examples of the optical disk 26a may include, for example, a DVD (Digital Versatile Disc), a DVD-RAM, a CD-ROM (Compact Disc Read Only Memory), and a CD-R (Recordable)/RW (ReWritable).

The device connection interface 27 is a communication interface for connecting peripheral devices to the compute node 200. For example, a memory device 27a and a memory reader/writer 27b may be connected to the device connection interface 27. The memory device 27a is a non-transitory recording medium having a function of communication with the device connection interface 27, such as, for example, a USB (Universal Serial Bus) memory. The memory reader/writer 27b writes data to the memory card 27c or reads data from the memory card 27c. The memory card 27c is a card type non-transitory recording medium.

The network interface 28 is connected to the network 201. The network interface 28 exchanges data with other computers (the compute node 200 and the job management node 100) or communication devices via the network 201. The hardware configuration of the compute node 200 is not limited thereto but may be implemented with appropriate modifications. For example, the configurations of parts of, for example, the graphic processor device 24, the monitor 24a, the input interface 25, the keyboard 25a, and the mouse 25b may be omitted.

The processor 21 controls the overall operation of the compute node 200. The processor 21 may be a multiprocessor. The processor 21 may be one of, for example, a CPU, an MPU (Micro Processing Unit), a DSP (Digital Signal Processor), an ASIC (Application Specific Integrated Circuit), a PLD (Programmable Logic Device), and an FPGA (Field Programmable Gate Array). Further, the processor 21 may be a combination of two or more elements of the CPU, MPU, DSP, ASIC, PLD, and FPGA.

The compute node 200 executes a program (e.g., a compute node control program) recorded on a computer readable non-transitory recording medium, for example, to implement a job computation processing function and the compute node management function. A program describing the contents of processing to be executed by the compute node 200 may be recorded in various recording media. For example, a program to be executed by the compute node 200 may be stored in the HDD 23. The processor 21 loads at least a part of the program in the HDD 23 into the RAM 22 and executes the loaded program.

Further, the program to be executed by the compute node 200 (the processor 21) may be recorded in a portable non-transitory recording medium such as the optical disk 26a, the memory device 27a, or the memory card 27c. The program stored in the portable recording medium is installed in the HDD 23, and then, is executed under the control of the processor 21. Further, the processor 21 may read and execute the program directly from the portable recording medium.

Then, in the compute node 200, the processor 21 executes the compute node control program to implement the job computation processing function and the compute node management function.

The job computation processing function controls job execution. The job computation processing function controls, for example, start of execution, monitoring and termination of the execution state of a job requested to be executed (computed) from the job management node 100 to be described later. “Requesting the compute node 200 to execute a job” by the job management node 100 may be sometimes referred to as “allocating a job.”

In addition, the job computation processing function may manage some computation resources in response to a job processing (execution) request transmitted from the job management node 100.

Each process such as execution of a job in the compute node 200 may be implemented by using a known method, and detailed description thereof will be omitted.

In the job computation processing function, the processing result (computation result) of a job may be transmitted to another compute node 200 or a host device (not illustrated) as a job request source via the network 201 as needed.

The compute node management function manages the compute node 200 (which may be hereinafter sometimes referred to as an own compute node 200) on which the compute node management function operates.

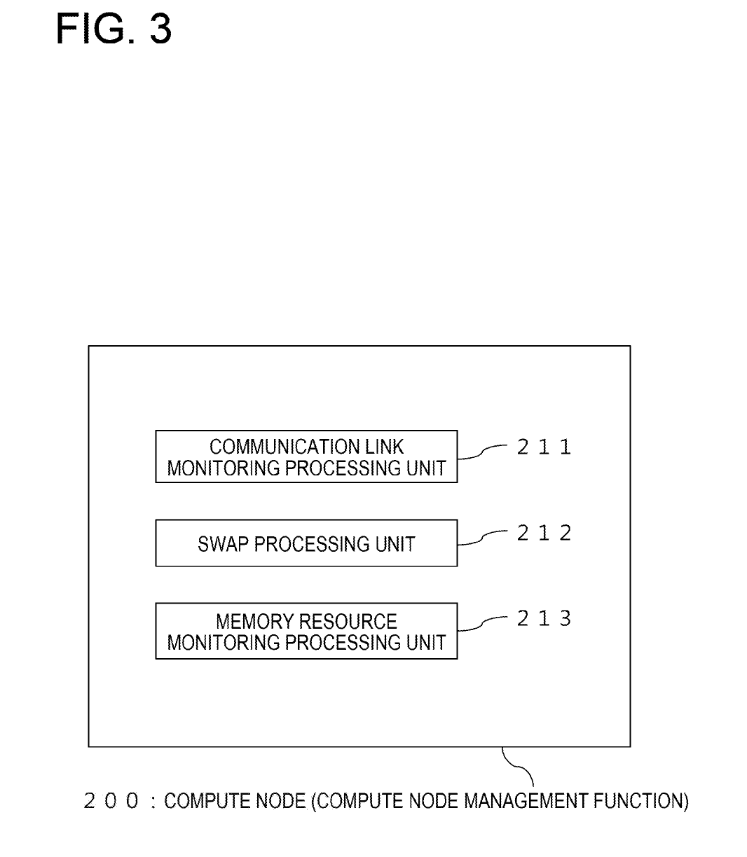

FIG. 3 is a block diagram illustrating an example of the functional configuration of the compute node 200 in the parallel computer system 1 according to the embodiment, illustrating a functional configuration for implementing the compute node managing function.

As illustrated in FIG. 3, the compute node 200 is equipped with functions as a communication link monitoring processing unit 211, a swap processing unit 212 and a memory resource monitoring processing unit 213 to implement a function as the compute node management function.

As a monitoring process, the communication link monitoring processing unit 211 monitors a link from the own compute node 200 in the network 201.

The network 201 constituting the compute node group 202 may be regarded as a combination of plural communication links (hereinafter simply referred to as links) via one or more relay devices (not illustrated).

The communication link monitoring processing unit 211 acquires the data communication amount per unit time in each link (the unit of transfer rate is bps (bit per second)). The acquisition of the data communication amount on the link may be implemented using various known methods.

Here, the link from the own compute node 200 is a communication path connecting the own compute node 200 and another compute node 200 in the network 201. The link from the own compute node 200 is appropriately determined depending on the configuration and type of the network 201.

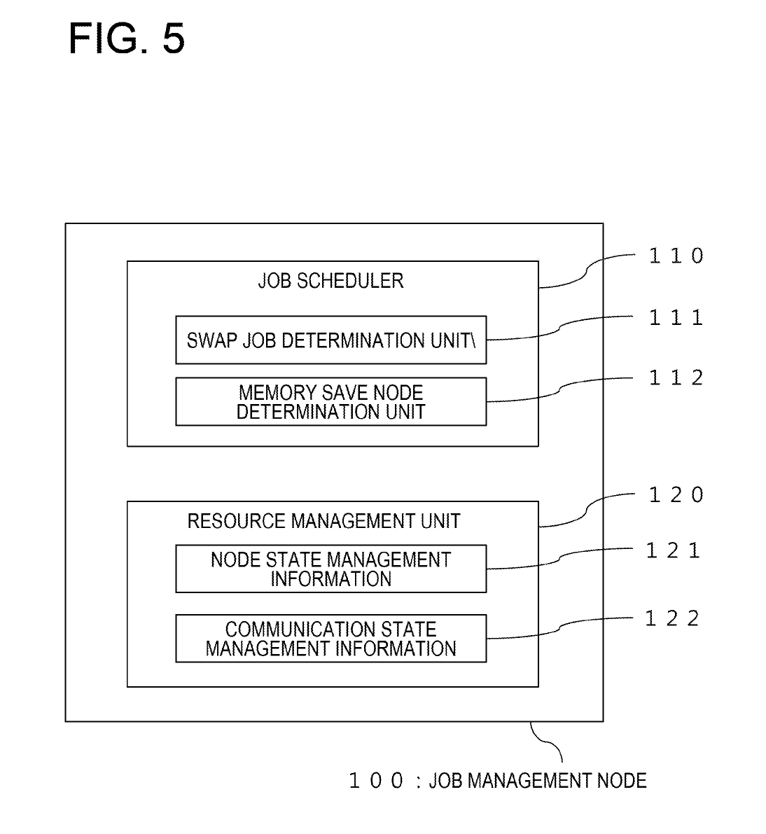

The communication link monitoring processing unit 211 periodically transmits information (actual measurement value) of the acquired data communication amount of each link to a resource management unit 120 (see, e.g., FIG. 5) of the job management node 100.

With a job swap execution request received from the job management node 100 as a trigger, the swap processing unit 212 transmits memory data (swap target data and swap data) of the running job in the RAM 22 to another compute node 200 (a swap destination compute node 200 or a save destination compute node 200) and stores (saves) the data in the RAM 22 (buffer) of the swap destination compute node 200 to implement swap-out.

In the following description, data communication from the swap source compute node 200 to the swap destination compute node 200, which is performed with the swap-out or transfer of swap data to a free node 200, may be sometime referred to as swap communication (managed communication).

In addition, communication other than the swap communication, which is communication occurring in a link by executing a job in the compute node 200, may be sometimes referred to as non-swap communication (unmanaged communication).

In the parallel computer system 1, the free node 200 refers to a compute node 200 having a free area in the RAM 22.

Further, the swap source compute node 200 may be referred to as a memory save source node 200, and the swap destination compute node 200 may be referred to as a memory save destination node 200.

When receiving a swap instruction together with a save memory amount and the swap destination compute node 200 from the job management node 100 (a job scheduler 110; see, e.g., FIG. 5), the swap processing unit 212 reads swap data corresponding to the save memory amount from the RAM 12 and transmits the read swap data to the swap destination compute node 200.

In addition, the swap processing unit 212 requests another compute node 200 (the swap destination compute node 200) at the save destination of the swap data to transmit the swap data to get back the memory data saved in the another compute node 200. For example, the swap processing unit 212 transmits a predetermined signal (swap data recovery request signal) requesting the swap destination compute node 200 to transmit the swap data.

The swap processing unit 212 stores (deploys) the swap data transmitted (recovered) in response to the swap data recovery request signal in the RAM 12 to return the own compute node 200 to the state before the start of the swap. That is, the swap processing unit 212 restores the swap data.

Further, when the swap data is transmitted from another compute node 200, the swap processing unit 212 receives the swap data. The swap processing unit 212 stores (saves) the received swap data in a free area in the RAM 22. Further, when receiving the swap data recovery request signal (swap data recovery request) from the compute node 200 as a swap data transmission source (hereinafter referred to as the swap source compute node 200), the swap processing unit 212 transmits (responds with) the swap data stored in the RAM 22 of the own compute node 200.

The memory resource monitoring processing unit 213 monitors the usage status of the memory resources in the own compute node 200. For example, the memory resource monitoring processing unit 213 monitors the usage amount (memory usage amount) of the RAM 22 as the memory resource usage status. When the usage status changes, the memory resource monitoring processing unit 213 frequently notifies a changed memory usage to the resource management unit 120 of the job management node 100. The memory resource monitoring processing unit 213 may notify the resource management unit 120 of a size of an unused area (free memory amount) in the RAM 22.

In addition, the memory resource monitoring processing unit 213 determines whether or not the own compute node 200 may be used as a job swap destination, that is, whether or not the RAM 22 of the own compute node 200 has a space in which at least a part of the swap data of another compute node 200 may be stored, and notifies the job management node 100 of a result of the determination as a free node state. For example, when there is a free area equal to or larger than a predetermined value in the RAM 22, the memory resource monitoring processing unit 213 notifies the information indicating that it is a free node. In addition, the memory resource monitoring processing unit 213 may notify the job management node 100 of information indicating whether or not the own compute node 200 is executing a job, as the free node state.

Therefore, the memory resource monitoring processing unit 213 notifies the job management node 100 of information indicating the usage status of the own compute node 200.

Upon detecting a change in the usage status in the own compute node 200, the memory resource monitoring processing unit 213 may frequently transmit the updated information to the job management node 100 (the resource management unit 120), together with an update notification indicating that the usage status has changed.

In this parallel computer system 1, each compute node 200 corresponds to a node that is the unit of job arrangement. The compute node 200 may be simply referred to as a node 200.

(1-2) Job Management Node 100

The job management node 100 performs a control to cause one or more of the plural compute nodes 200 included in the compute node group 202 to execute a job. The job management node 100 is a parallel processing control device that allocates jobs to two or more compute nodes 200 that process two or more jobs in parallel.

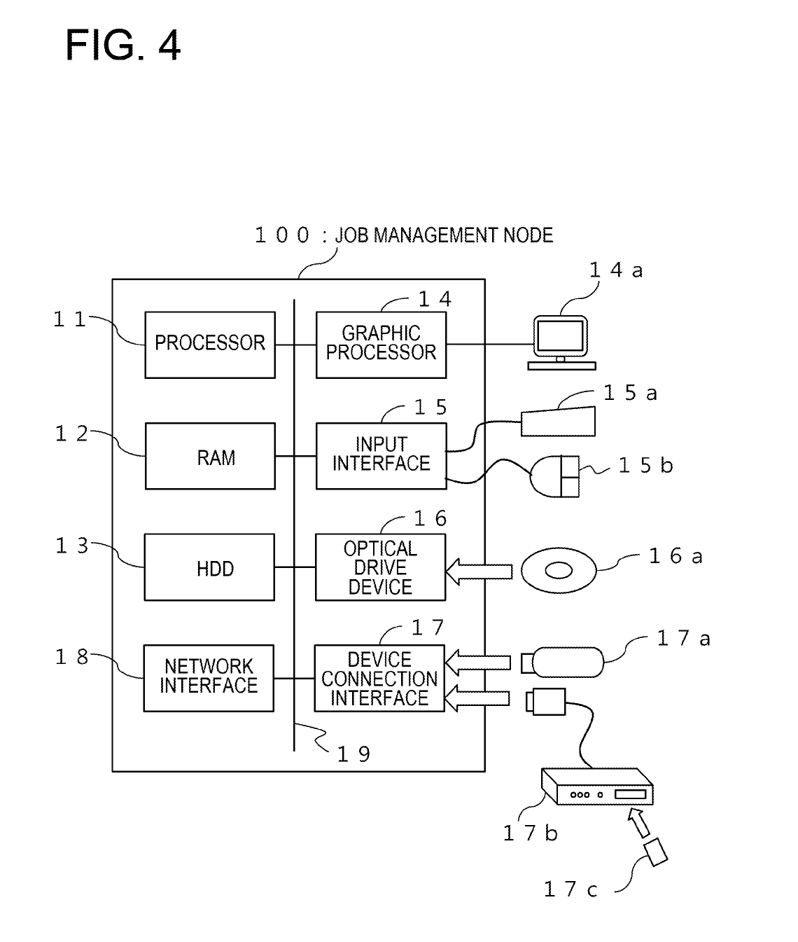

FIG. 4 is a block diagram illustrating an example of a hardware configuration of the job management node 100 of the parallel computer system 1 according to the embodiment.

As illustrated in FIG. 4, the job management node 100 includes, for example, a processor 11, a RAM 12, an HDD 13, a graphic processor 14, an input interface 15, an optical drive device 16, a device connection interface 17, and a network interface 18. These components 11 to 18 are configured to communicate with each other via a bus 19.

The processor 11, the RAM 12, the HDD 13, the graphic processor 14, the input interface 15, the optical drive device 16, the device connection interface 17, the network interface 18, and the bus 19 in the job management node 100 have the same functional configurations as the processor 21, the RAM 22, the HDD 23, the graphic processor 24, the input interface 25, the optical drive device 26, the device connection interface 27, the network interface 28, and the bus 29, respectively. Therefore, detailed description of these components will be omitted.

At least part of an OS program and an application program to be executed by the processor 11 is temporarily stored in the RAM 12. Various data required for processing by the processor 11 are stored in the RAM 12. The application program may include a job swap program to be executed by the processor 11 to implement the job management function of the present disclosure by the job management node 100.

The processor 11 controls the overall operation of the job management node 100. The processor 11 may be a multiprocessor. The processor 11 may be one of, for example, a CPU, an MPU, a DSP, an ASIC, a PLD, and an FPGA. Further, the processor 11 may be a combination of two or more elements of CPU, MPU, DSP, ASIC, PLD, and FPGA.

The job management node 100 executes a program (e.g., a job swap program) recorded on a computer readable non-transitory recording medium, for example, to implement the job swap control of the present embodiment. A program describing the contents of processing to be executed by the job management node 100 may be recorded in various recording media. For example, a program to be executed by the job management node 100 may be stored in the HDD 13. The processor 11 loads at least a part of the program in the HDD 13 into the RAM 12 and executes the loaded program.

Further, the program to be executed by the job management node 100 (the processor 11) may be recorded in a portable non-transitory recording medium such as an optical disk 16a, a memory device 17a, or a memory card 17c. The program stored in the portable recording medium is installed in the HDD 13, and then, is executable under the control of the processor 11. Further, the processor 11 may read and execute the program directly from the portable recording medium.

FIG. 5 is a block diagram illustrating an example of a functional configuration of the job management node 100 in the parallel computer system 1 according to the embodiment.

As illustrated in FIG. 5, the job management node 100 has functions as a job scheduler 110 and a resource management unit 120.

The resource management unit 120 manages information on each of the compute nodes 200 of the compute node group 202 of the parallel computer system 1.

As illustrated in FIG. 5, the resource management unit 120 manages node state management information 121 and communication state management information 122 and uses the information 121 and 122 to manage information on each of the compute nodes 200 of the compute node group 202 which is a computer resource.

The communication state management information 122 is information indicating a communication state of a communication path (link or route) connecting between the computation nodes 200 in the compute node group 202.

The resource management unit 120 acquires the data transfer amount (measured value and path state information) of each link transmitted from the communication link monitoring processing unit 211 of each of the compute nodes 200, and stores the data transfer amount in the communication state management information 122 for each link.

Therefore, in the communication state management information 122, for each compute node 200 included in the compute node group 202, the data transfer amount is registered in association with information specifying a link connected to each compute node 200. In addition, the data transfer amount of each link for a predetermined period, which was acquired in the past, is recorded in the communication state management information 122.

In addition, the communication state management information 122 may acquire the configuration information of the link connected to each compute node 200 from, for example, the communication link monitoring processing unit 211 of each compute node 200. In addition, for example, the system administrator may preset the configuration information of the link connected to each compute node 200.

The resource management unit 120 calculates the average value (moving average value) of the data transfer amount per predetermined period for each link based on the past data transfer amount recorded in the communication state management information 122. The resource management unit 120 uses this calculated average value as an estimated value (Le) of the data transfer amount for each link in the next unit time.

That is, the resource management unit 120 estimates the data transfer amount in non-swap communication for each link based on the data transfer amount recorded in the communication state management information 122.

However, such estimation of the data transfer amount may be appropriately modified using another method instead of calculating and using the average value (moving average value) of the data transfer amount per predetermined period.

Further, the resource management unit 120 calculates an estimated value of a usable bandwidth of each link for the swap destination compute node 200.

That is, in the swap communication performed by the plural compute nodes 200, the resource management unit 120 obtains an estimated value (Lb) of the bandwidth usable for swap communication for each combination of the compute nodes 200, via a link commonly used for simultaneously communicating to each swap destination compute node 200, based on the estimated value of the data transfer amount in non-swap communication.

For example, the estimated value (Lb) of the bandwidth usable for the swap communication may be calculated by subtracting the estimated bandwidth (Le) of the data transfer amount of the link in the next unit time from the bandwidth of the specification of the link.

For example, in a link having the bandwidth of 100 Mbps when the estimated value (Le) of the data transfer amount is 20 Mbps, the resource management unit 120 calculates the estimated value (Lb) of 80 (=100−20) Mbps of the usable bandwidth of the link.

Further, the resource management unit 120 sets the upper limit value of the bandwidth of each link based on the estimated value (Lb) of the usable bandwidth in the link calculated as described above. That is, the resource management unit 120 sets the upper limit value of the transfer amount of the data that may be transmitted on each link when performing the swap communication.

Specifically, the resource management unit 120 uses, as the upper limit value, the bandwidth of a link which is a bottleneck at the time of transfer from the plural compute nodes 200 to one destination (the swap destination compute node 200) at the same time. That is, the minimum value among the estimated values (Lb) of the usable bandwidths of one or more links commonly used by the plural swap communications is referred to as an estimated value (Lb) of usable bandwidth on the link.

The node state management information 121 is information indicating the usage status of each of the compute nodes 200 in the compute node group 202.

The information indicating the usage status of the compute node 200 may be, for example, a free node state, a CPU usage rate, or a free memory amount.

The free node state indicates whether or not there is an enough space in the RAM 22 of the compute node 200 to store part of the swap data of another compute node 200. For example, when there is a free area equal to or larger than a predetermined value in the RAM 22, a value indicating that it is a free node is set.

The free memory amount is the capacity of an area not used in the RAM 22 of the compute node 200.

The information indicating the usage status of these compute nodes 200 is transmitted from, for example, the memory resource monitoring processing unit 213 of each compute node 200.

By referring to the free node state in the node state management information 121, it is possible to know a free node 200 usable as the swap destination compute node 200. Further, by referring to the free memory amount, it is possible to grasp the memory remaining amount of each free node 200.

The above-described node status management information 121 and communication state management information 122 are used by the job scheduler 110.

The job scheduler 110 makes an execution reservation for a job requested (submitted) from, for example, a host device (not illustrated). For example, the job scheduler 110 creates and manages, as execution reservation information, a pair of information indicating a compute node 200 (compute node resource) of a job allocation destination and information indicating a time zone during which the compute node 200 may be used.

Then, referring to this execution reservation information, the job scheduler 110 requests the allocation destination compute node 200 to execute a job, for example, at the time scheduled in the execution reservation information.

As illustrated in FIG. 5, the job scheduler 110 has functions as a swap job determination unit 111 and a memory save node determination unit 112.

In this parallel computer system 1, when an emergency job is input from, for example, a host device, job swap is performed when there is no compute node 200 to which the emergency job is allocated.

When executing a job swap, the swap job determining unit 111 determines which job is to be swapped out of one or more jobs currently being executed in the compute node group 202. That is, the swap job determination unit 111 selects a swap source compute node 200 from the plural compute nodes 200 constituting the compute node group 202.

The method of determining the job to be swapped, that is, the method of selecting the swap source compute node 200, may be implemented by using various known methods, and description thereof will be omitted.

When performing a job swap, the memory save node determination unit 112 determines how much swap data (memory data) should be saved in which compute node 200. Furthermore, the memory save node determination unit 112 issues a swap request to the compute node 200 of the job to be swapped out.

The memory save node determining unit 112 limits (selects) a candidate of the swap destination compute node 200 serving as a transmission destination (save destination) of the swap data in the next unit time in the swap communication, among the plural compute nodes 200 of the compute node group 202.

Hereinafter, the candidate compute node 200 of the swap destination compute node 200 may be sometimes referred to as a swap destination compute node candidate 200.

The memory save node determination unit 112 selects one or more swap destination compute node candidates 200 from the free nodes 200 in the compute node group 202 in accordance with a predefined candidate selection policy.

The candidate selection policy is, for example, that the communication latency from the swap source compute node 200 is within a predetermined time. However, the candidate selection policy is not limited thereto but may be modified appropriately.

The memory save node determination unit 112 selects a predetermined number of compute nodes 200 that satisfy the candidate selection policy from the compute nodes 200 of the compute node group 202 as the swap destination compute node candidate 200. The number (predetermined number) of swap destination compute node candidates 200 to be selected is 1 or more, particularly two or more.

Then, the memory save node determining unit 112 determines one or more swap destination compute nodes 200 from each compute node 200 by a linear programming method with the sum of data transfer amounts from all the compute nodes 200 as the objective function of maximization and determines the size (optimum transfer amount) of the swap data to be swapped to each swap destination compute node 200 (transfer destination).

That is, the memory save node determination unit 112 selects all the compute nodes 200 as objects of the swap destination compute node 200, and solves a problem of the linear programming method which maximizes the data transfer performance to the selected compute node 200. As a result, one or more swap destination compute nodes 200 are determined from each compute node 200 and the size (optimum transfer amount) of swap data to be swapped to each swap destination compute node 200 (transfer destination) is determined.

In this way, the memory save node determination unit 112 handles a control of “selecting one specific free node 200 in order to obtain the swap destination compute node 200 of the job on a certain compute node 200 and maximizing the transfer performance of swap data to the selected compute node 200” as a control of “maximizing the transfer performance of swap data to the selected compute node 200 taking the swap destination compute nodes 200 as the entire compute nodes 200.”

Symbols used in the description of this embodiment are defined as follows.

C={1, 2, . . . , m}: This is a set of serial numbers of the compute nodes 200 that perform the swap communication in the next unit time, and is given as an input value from the outside.

E={1, 2, . . . , N}: This is a set of serial numbers of the swap destination compute node candidates 200 (free nodes 200) limited by the memory save node determination unit 112.

For r(j): j∈E, the free memory amount of the j-th free node 200. This free memory amount may be grasped by referring to the node state management information 121.

d(j): This is a set of compute nodes 200 permitted to perform the swap communication to the j-th free node 200.

L: This is a set of links appearing on a path to the j-th free node 200 from a compute node 200 belonging to d(j).

B(I, j): I∈L: This is the bandwidth (maximum transfer amount per unit time) of a link as a bottleneck set by the resource management unit 120. That is, it is the upper limit value of the transfer amount of transmittable data on a path to the j-th free node 200.

A linear programming method used by the memory save node determination unit 112 will be illustrated below.

Variables

For the swap communication to be performed in the next unit time, the data transfer amount and the time required for data transfer from each computation node 200 to each free node 200 limited by the memory save node determination unit 112 are set as variables.

X(i,j): This is a variable representing the data transfer amount to be transferred from the i-th compute node 200 to the j-th free node 200 in the next unit time.

t(i,j): This is a constant representing the time required for data transfer from the i-th compute node 200 to the j-th free node 200. However, this time may be arbitrarily set by the job scheduler 110.

Constraint Expression

The following constraint expression (1) is a first-order inequality that requires that the total of the data transfer amounts transferred to a specific swap destination compute node 200 is equal to or less than the free memory amount of this specific swap destination compute node 200. When a job to be swapped is processed by the plural compute nodes 200, “i” (the number of swap source compute nodes 200) is 2 or more.

The constraint expression (2) is a first-order inequality that requires that the total of the data transfer amounts transferred to a specific swap destination compute node 200 is equal to or less than the bandwidth of a link which is a bottleneck among paths reaching this specific swap destination compute node 200.

The constraint expression (1) (j=1,2, . . . , N) regarding the free memory amount

$${\sum }_{i} x ( i , j ) * t ( i , j ) ≦ r ( j ) \qquad ( 1 )$$

The constraint expression (2) (j=1,2, . . . , N) regarding the transfer bandwidth

$${\sum }_{i ∈ d ( j )} x ( i , j ) ≦ B ( l , j ) \qquad ( 2 )$$

Objective function for maximization (total value of transfer amount from each free node to each compute node)

$${\sum }_{i , j} x ( i , j ) \qquad ( 3 )$$

The calculation result “i, j: z” may be obtained by obtaining each variable x (i,j) at the time of giving the maximum value of the above objective function (3).

Where, “z” represents the data transfer amount (swap memory amount or save memory amount) to be transferred (swapped) from the i-th compute node 200 to the j-th free node 200.

The memory save node determining unit 112 specifies the swap source compute node 200 and the swap destination compute node 200 based on “i” and “j” obtained by the linear programming method as described above. Then, the memory save node determination unit 112 creates an instruction to transmit (swap) data (swap memory amount or save memory amount) corresponding to the data size “z” among the swap data in the RAM 22 of the swap source compute node 200, with “z” obtained by the linear programming method as the data transfer amount.

For example, the memory save node determining unit 112 instructs the swap source compute node 200 to transmit the swap data of the save memory amount to the swap destination compute node 200. In addition, the memory save node determination unit 112 instructs the swap destination compute node 200 to store the swap data transmitted from the swap source compute node 200 in the RAM 22.

When the swap source compute node 200 and the swap destination compute node 200 perform a process in accordance with these instructions, job swapping from the swap source compute node 200 to the swap destination compute node 200 is completed.

It may be considered that there is a case where an appropriate free node 200 does not exist with respect to the constraint expression on the free memory amount. In such a case, for example, the swap-out of the swap source compute node 200 to the HDD 23 may be executed.

A method of determining the swap destination compute node 200 using the linear programming method by the memory save node determining unit 112 will be exemplified.

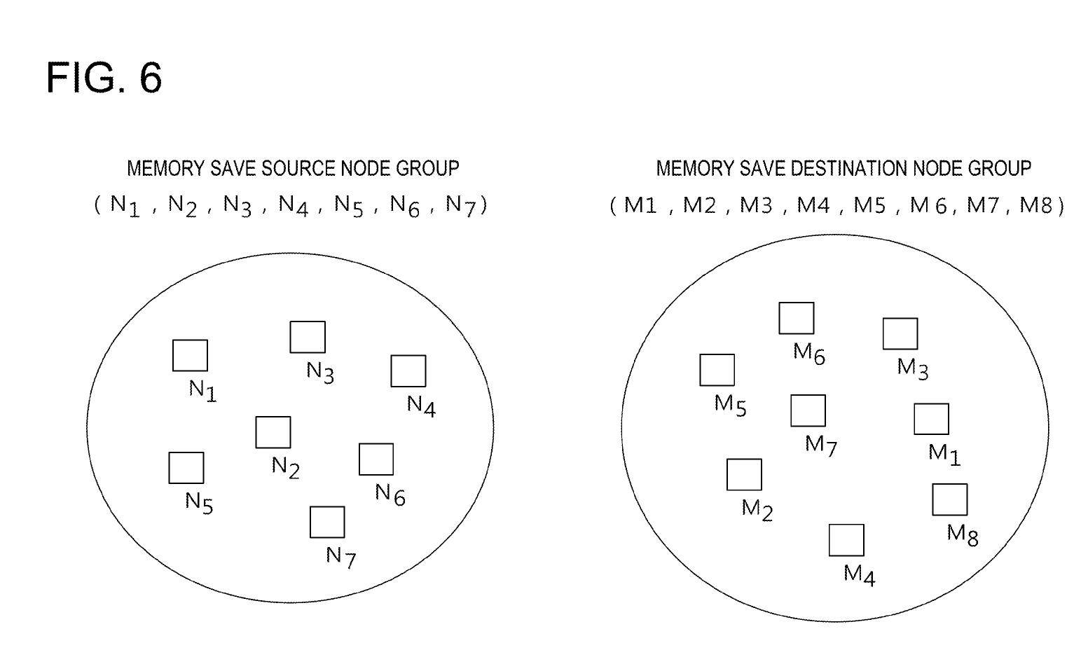

FIG. 6 is a view for explaining a method of determining a job swap source and a job swap destination in the parallel computer system 1 according to the embodiment. The example illustrated in FIG. 6 represents a swap source compute node group including plural swap source compute nodes 200 (N₁ to N₇) and a swap destination compute node group including plural swap destination compute nodes 200 (M₁ to M₈).

Hereinafter, the swap source compute nodes N₁ to N₇ may be expressed as a compute node Nᵢ (i=1, 2, . . . , 7). The swap destination compute nodes M₁ to M₈ may be expressed as a compute node Mⱼ (j=1, 2, . . . , 8).

The compute nodes Mj are communicably connected to the swap source compute nodes N₁ to N₇, respectively.

The variable X(i,j) represents the data transfer amount per second from a swap source compute node Nᵢ to a swap destination compute node Mⱼ.

The variable t(i,j) represents a time taken for data transfer from the compute node Nᵢ to the compute node Mⱼ, which may be a value determined in advance by the job scheduler 110 or the like.

The symbol r(j) represents the free memory amount (unit; byte) in the compute node Mⱼ.

In this case, by applying the linear programming method, it is expressed as follows. The linear programming method may use a known standard method such as a simplex method.

X(i,j)≥0 “i” and “j” are arbitrary values.

The constraint expression for data transfer amount related to the free memory 22 is as follows.

$${\sum }_{i = 1}^{7} x ( i , j ) t ( i , j ) ≦ r ( j )$$

$$( j = 1 , 2 , … 8 )$$

In addition, the constraint expression for transfer bandwidth is as follows.

$${\sum }_{i = 1}^{7} x ( i , j ) ≦ r ( j )$$

$$( j = 1 , 2 , … 8 )$$

Where B(j) is the usable bandwidth (unit: bytes/second) when communicating to a compute node MW.

The objective function of maximization is as follows.

$${\sum }_{j = 1}^{8} {\sum }_{i = 1}^{7} x ( i , j )$$

The memory save node determination unit 112 obtains {x(i,j)} (i=1, 2, . . . , 7 and j=1, 2, . . . , 8) which maximizes this objective function.

(2) Operation

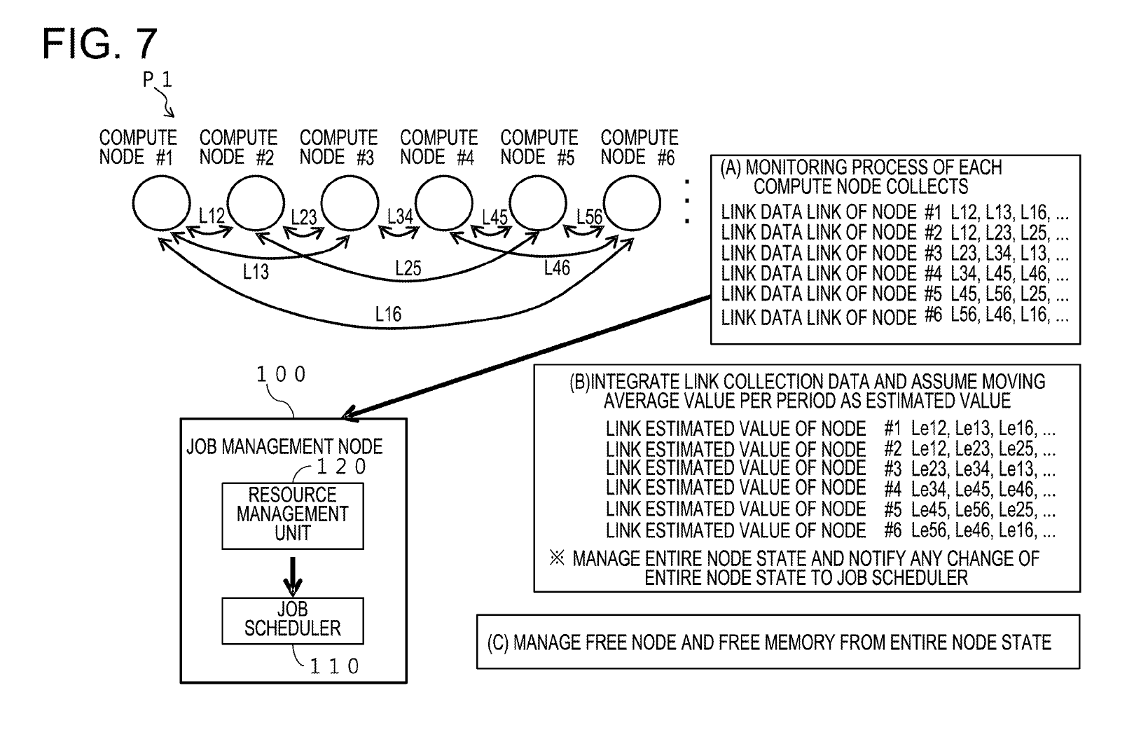

First, a method of determining a job swap destination in the parallel computer system 1 according to the embodiment will be described with reference to FIGS. 7 to 9. The following method of determining a job swap destination includes processes (A) to (H).

Each of the examples illustrated in FIGS. 7 to 9 illustrates six compute nodes 200 (see, for example, an arrow P1 in FIG. 7). In addition, in the examples illustrated in FIGS. 7 to 9, arbitrary compute nodes 200 are identified by assigning symbols #1 to #6 to these compute nodes 200. Hereinafter, numbers included in these symbols #1 to #6 may be sometimes referred to as node identification numbers.

In addition, in the examples illustrated in FIGS. 7 to 9, a link connecting between the compute nodes 200 is represented by appending the node identification number of each compute node 200 connected to both ends of the link to a character L. For example, a link connecting a compute node #1 and a compute node #2 is denoted by reference symbol L12.

Process (A): In each compute node 200, the communication link monitoring processing unit 211 collects the data transfer amount per unit time for each link (see reference symbol A in FIG. 7). The communication link monitoring processing unit 211 transmits the collected data communication amount of each link to the resource management unit 120 of the job management node 100.

Process (B): In the job management node 100, the resource management unit 120 records the information on the data transfer amount for each link transmitted from each compute node 200 in the communication state management information 122 (see reference symbol B in FIG. 7).

Based on the transition record of the data transfer amount monitored in each link, the resource management unit 120 calculates a moving average value of the data transfer amounts in the unit time next for each link generated by the non-swap communication and takes the calculated moving average value as an estimated value (Le).

In the example illustrated in FIG. 7, for each compute node 200, the resource management unit 120 calculates a moving average value of the data transfer amounts per predetermined period for each link connected to each compute node 200 as an estimated value (Le12, Le13, . . . ).

In addition, the resource management unit 120 manages an estimated value of data of each link for all the compute nodes 200 and notifies the estimated value to the job scheduler 110 when a change occurs in the estimated value.

Process (C): The resource management unit 120 uses the node state management information 121 for job swap communication to manage the available free node 200 and the remaining memory capacity of each free node 200 (see reference symbol C in FIG. 7).

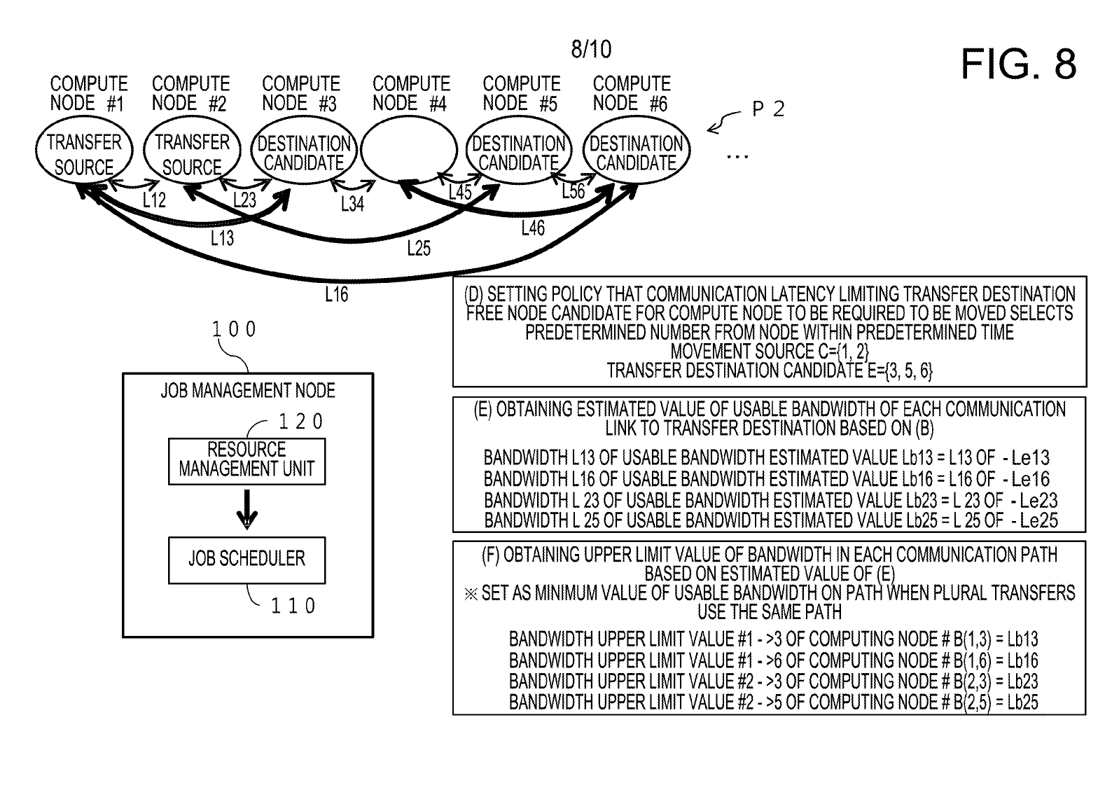

Process (D): The memory save node determination unit 112 limits the swap destination compute node candidate 200 (see reference symbol D in FIG. 8). The memory save node determination unit 112 extracts compute nodes 200 whose communication latency from the swap source compute node 200 is within a predetermined time, from the compute node group 202, and takes a predetermined number of compute nodes 200 among the extracted ones, as swap destination compute node candidates 200.

In the example illustrated in FIG. 8, compute nodes #1 and #2 are swap source compute nodes 200 and compute nodes #3, #5, and #6 are swap destination candidate compute nodes 200 (see an arrow P2).

Process (E): Based on the estimated value (Le) of the data transfer amount in the next unit time of each link obtained in the process (B), the resource management unit 120 obtains an estimated value of the usable bandwidth for each link (see reference symbol E in FIG. 8).

Regarding the swap communication performed between the plural compute nodes 200, the resource management unit 120 obtains an estimated value (Lb) of the bandwidth usable for swap communication for each link for each combination of compute nodes 200.

“Estimated value of usable bandwidth for swap communication (Lb)”=“Bandwidth on specification of the relevant link”−“Estimated value (Le) of data transfer amount of the relevant link in the next unit time”

Process (F): Based on the estimated value (Lb) of the usable bandwidth obtained in the process (E), the resource management unit 120 sets the upper limit value of the transfer amount possible for each communication path when the swap communication is simultaneously performed (see reference symbol F in FIG. 8).

Specifically, it is assumed that “bandwidth of bottleneck when transferring from plural compute nodes 200 to one destination at the same time”=“the minimum value of estimated value of usable bandwidth in link used in common.”

When the data transfer of the plural swap communications uses the same path, the minimum value of the usable bandwidth on the path is used.

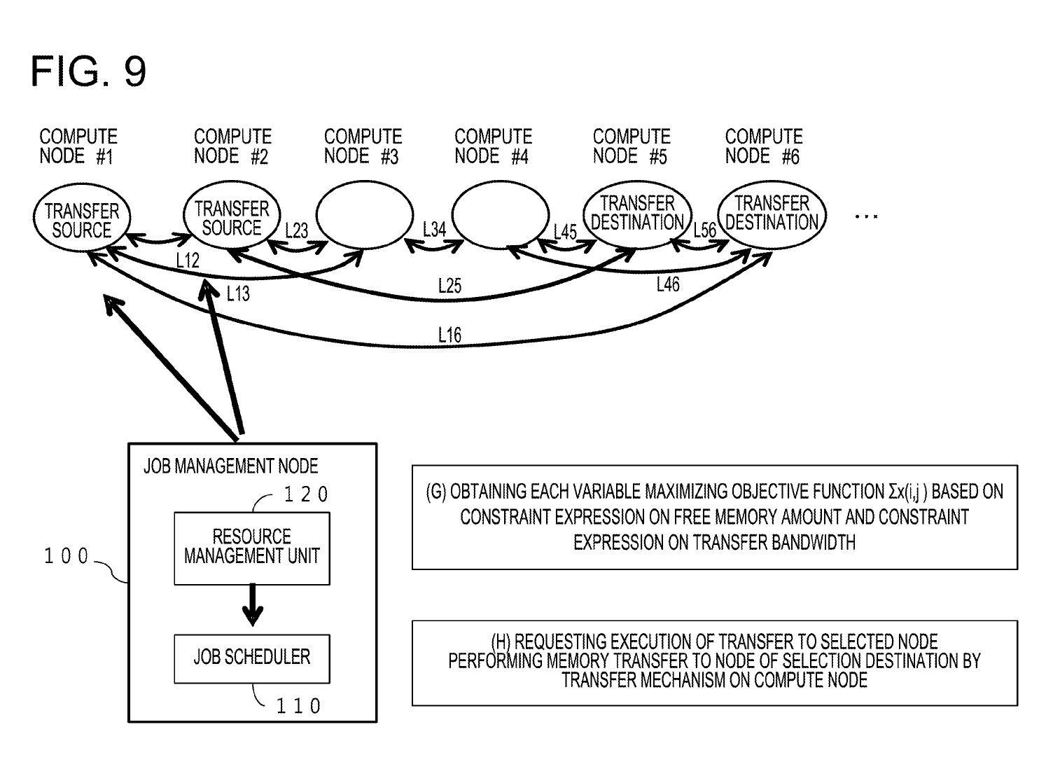

Process (G): The memory save node determination unit 112 determines the optimum transfer amount to each swap destination compute node 200 (transfer destination) from each compute node 200 in accordance with a linear programming method with the sum of data transfer amounts from all the compute nodes 200 as the objective function of maximization (see reference symbol G in FIG. 9).

The memory save node determination unit 112 uses a constraint expression on the free memory amount and a constraint expression on the transfer bandwidth to obtain a variable x(i,j) maximizing the sum of transfer amounts to each free node 200 from each compute node 200. Further, in the linear programming method, the optimum transfer amount to the swap destination compute node 200 from each swap source compute node 200 is also obtained.

Process (H): The memory save node determination unit 112 requests the swap source compute node 200 selected in the process (G) to transfer (swap) the data of the calculated optimum transfer amount to the swap destination compute node 200. Thus, the swap transfer is executed (see reference symbol H in FIG. 9).

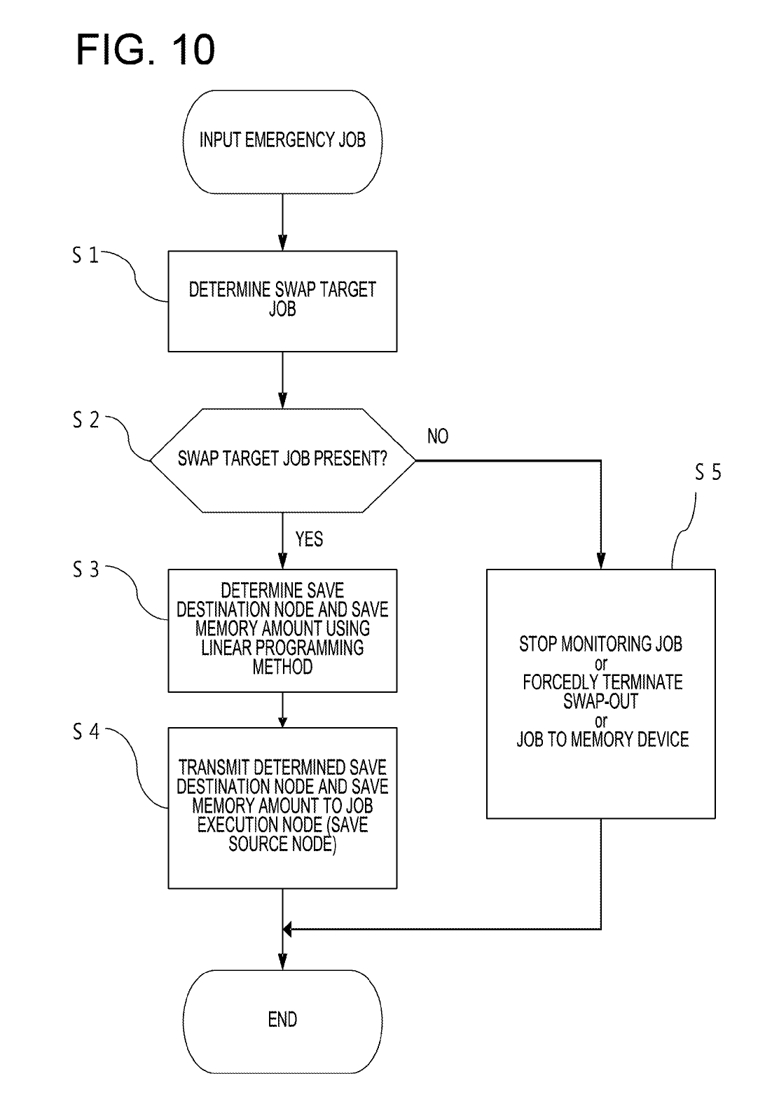

Next, a process of the job management node 100 when an emergency job is input in the parallel computer system 1 according to the embodiment will be described in accordance with a flowchart (steps S1 to S5) illustrated in FIG. 10.

When an emergency job is input to the parallel computer system 1, in step S1, the swap job determination unit 111 of the job scheduler 110 determines a job to be swapped, among jobs being executed in the compute nodes 200 of the compute node group 202.

In step S2, the job scheduler 110 checks whether or not there is a job that may be set as a swap target, among the jobs being executed in the compute nodes 200 of the compute node group 202.

When it is checked that there is no job to be swapped (see “NO” route of step S2), the process proceeds to step S5.

In step S5, the execution of the emergency job is blocked. Alternatively, swap-out of the swap source compute node 200 to the HDD 23 may be executed, or the job may be forcibly terminated. Thereafter, the process is ended.

When it is checked in step S2 that there is a job to be swapped (see “YES” route of step S2), the process proceeds to step S3.

In step S3, the memory save node determining unit 112 uses the linear programming method to determine the swap destination compute node 200 and the save memory amount.

In step S4, the memory save node determination unit 112 transmits the swap destination compute node 200 and the save memory amount determined in step S3 to the job execution node 200 (swap source compute node 200). Thereafter, the process is ended.

(3) Effects

In this way, in the parallel computer system 1 according to the embodiment, it is possible to easily determine the swap destination compute node 200 which is the swap destination of a job (stopping coping job) whose execution is stopped due to the input of the emergency job.

That is, in the job management node 100, the memory save node determination unit 112 determines the optimum transfer amount to each swap destination compute node 200 (transfer destination) from each compute node 200 in accordance with a linear programming method with the sum of data transfer amounts from all the compute nodes 200 as the objective function of maximization.

The linear programming method is a computational method by which the increase in computational time accompanying the increase of a variable is moderate, and may be executed at high speed for a large scale system, for example, by a simplex method. Further, the linear programming method may be used to easily obtain the swap destination and the swap size and easily save a job of one swap destination compute node 200 to the plural swap destination compute nodes 200, which may provide high convenience.

In this parallel computer system 1, a control of “selecting one specific free node as a job swap destination on a certain node and maximizing the transfer performance of swap data to the selected node” is treated as a mathematical optimization problem. Accordingly, this control may be treated as a problem of a kind called “combination optimization” that defines the correspondence relationship between a node executing a job to be swapped and a data save destination node or “integer programming method” that defines the value of a variable that takes only values of 0 and 1 indicating the presence/absence of the correspondence relationship. Thus, it is possible to easily implement the optimum swap destination node determination, which has been conventionally difficult.

In this parallel computer system 1, the amount of data transfer in communication other than swapping for each link of the network 201 within a unit time and the amount of free memory of the swap destination compute node 200 of the job swap-out data in this parallel computer system 1 are set as input variables. In addition, the data transfer amount in the unit time to each swap destination compute node 200 is set as an output variable. Then, the memory save node determining unit 112 sets the communication amount determined by the linear programming method with the total data transfer amount in the swap-out within the unit time as the objective function of maximization, as the transfer amount of each compute node to each transfer destination (swap destination). As a result, it is possible to implement the data transfer amount per unit time, that is, the transfer with the maximum transfer bandwidth. Therefore, when an emergency job is input, the job may be efficiently processed.

In the parallel computer system 1, a control of “selecting one specific free node 200 in order to obtain the swap destination compute node 200 of a job on a certain compute node 200 and maximizing the transfer performance of swap data to the selected compute node 200” is handled as a control of “maximizing the transfer performance of swap data to the selected compute node 200 taking the swap destination compute nodes 200 as the entire compute node 200.” Accordingly, by treating this control as a problem of “linear programming method” rather than treating the control as a problem of a kind called “combinatorial optimization” or “integer programming method” which requires complicated computation, it is possible to avoid the complicated computation and speed up the control process.

(4) Others

The disclosed techniques are not limited to the above-described embodiments but various modifications thereof may be made without departing from the spirit and scope of the present embodiments. The configurations and processes of the present embodiments may be selected as needed or may be used in proper combination.

For example, in the above-described embodiments, the memory save node determination unit 112 uses the constraint expression (1) on the free memory amount and the constraint expression (2) on the transfer bandwidth. However, the present disclosure is not limited thereto but may use other constraint expressions.

Further, some of the functions of the job management node 100 may be executed by another information processing apparatus. For example, the function as the memory save node determination unit 112 in the job management node 100 may be executed by some compute nodes 200, thereby reducing the processing load on the job scheduler 110 in the job management node 100.

Moreover, according to the above disclosure, the present embodiments may be made and practiced by those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel processing control device, comprising:
a memory; and
a processor coupled to the memory and the processor configured to:
acquire path status information indicating a communication status of each path connecting between compute nodes;
acquire free memory information indicating a status of memory usage in each of the compute nodes;
determine, when a new job is input, a save target job from among jobs processed by at least a part of the compute nodes; and
determine, by evaluating data transfer from the respective compute nodes to respective acceptable nodes based on the free memory information and the path status information, destination nodes and a size of data to be transferred between respective pairs of one of source nodes and one of the destination nodes, the acceptable nodes being compute nodes having a free memory, the destination nodes being compute nodes to which a part of data of the save target job is to be transferred from the respective source nodes, the source nodes being compute nodes processing the save target job.

2. The parallel processing control device according to claim 1, wherein
the processor is further configured to:
determine the destination nodes and the size of data by solving a problem of a linear programming method in which performance of data transfer to all the compute nodes is to be maximized.

3. The parallel processing control device according to claim 1, wherein
the processor is further configured to:
determine the pairs of nodes and the size of data based on a first constraint expression regarding an amount of a free memory in the respective compute nodes and a second constraint expression regarding a bandwidth of each path such that a value of an objective function is to be maximized, the objective function being defined as a sum of amounts of data transferred from the respective compute nodes to the respective acceptable nodes.

4. The parallel processing control device according to claim 1, wherein
the processor is further configured to:
select candidates for the destination nodes from among the compute nodes in accordance with a candidate selection policy; and
determine the destination nodes from among the selected candidates.

5. A non-transitory computer-readable recording medium having stored therein a program that causes a computer to execute a process, the process comprising:
acquiring path status information indicating a communication status of each path connecting between compute nodes;
acquiring free memory information indicating a status of memory usage in each of the compute nodes;
determining, when a new job is input, a save target job from among jobs processed by at least a part of the compute nodes; and
determining, by evaluating data transfer from the respective compute nodes to respective acceptable nodes based on the free memory information and the path status information, destination nodes and a size of data to be transferred between respective pairs of one of source nodes and one of the destination nodes, the acceptable nodes being compute nodes having a free memory, the destination nodes being compute nodes to which a part of data of the save target job is to be transferred from the respective source nodes, the source nodes being compute nodes processing the save target job.

6. The non-transitory computer-readable recording medium according to claim 5, the process further comprising:
determining the destination nodes and the size of data by solving a problem of a linear programming method in which performance of data transfer to all the compute nodes is to be maximized.

7. The non-transitory computer-readable recording medium according to claim 5, the process further comprising:
determining the pairs of nodes and the size of data based on a first constraint expression regarding an amount of a free memory in the respective compute nodes and a second constraint expression regarding a bandwidth of each path such that a value of an objective function is to be maximized, the objective function being defined as a sum of amounts of data transferred from the respective compute nodes to the respective acceptable nodes.

8. The non-transitory computer-readable recording medium according to claim 5, the process further comprising:
selecting candidates for the destination nodes from among the compute nodes in accordance with a candidate selection policy; and
determining the destination nodes from among the selected candidates.

9. A computer system, comprising:
compute nodes each including:
a first memory; and
a first processor coupled to the first memory; and
a parallel processing control device including:
a second memory; and
a second processor coupled to the second memory and the second processor configured to:
acquire path status information indicating a communication status of each path connecting between the compute nodes;
acquire free memory information indicating a status of memory usage in each of the compute nodes;
determine, when a new job is input, a save target job from among jobs processed by at least a part of the compute nodes; and
determine, by evaluating data transfer from the respective compute nodes to respective acceptable nodes based on the free memory information and the path status information, destination nodes and a size of data to be transferred between respective pairs of one of source nodes and one of the destination nodes, the acceptable nodes being compute nodes having a free memory, the destination nodes being compute nodes to which a part of data of the save target job is to be transferred from the respective source nodes, the source nodes being compute nodes processing the save target job.
